(19) United States
(12) Patent Application Publication
(10) Pub. No.: US 2013/0102195 A1
(43) Pub. Date: Apr. 25, 2013

(54) Multiport RJ Stack Connector With Interlocking Mechanism to Attach to Additional Multiport Stack

(71) Applicant: Alan L. Pocrass, Simi Valley, CA (US)

(72) Inventor: Alan L. Pocrass, Simi Valley, CA (US)

(21) Appl. No.: 13/654,762

(22) Filed: Oct. 18, 2012

Related U.S. Application Data
(60) Provisional application No. 61/628,074, filed on Oct. 24, 2011.

(51) Int. Cl. H01R 13/66

(52) U.S. Cl. 439/620.23

(57) ABSTRACT

Disclosed is a multiport RJ connector that includes vertically stacked RJ-type female connectors, including from a bottom to a top first, second and third RJ-type female connectors. Each RJ-type female connector includes an opening that houses a plurality of contacts including contact portions arranged side-by-side. Each contact includes a contact pin that extends from the corresponding contact portion toward the bottom of the connector body. The lengths of the contacts pins of the first RJ-type female connector are longer than the contacts pins of the second RJ-type female connector which are longer than the contacts pins of the first RJ-type female connector. First and second complementary interlocking structures are included on opposite sides of the connector body. The first or second interlocking structure of the connector body is configured to mate with a respective second or first complementary interlocking structure of another connector body.

### CROSS REFERENCE TO RELATED APPLICATION

This application claims priority from U.S. Provisional Patent Application No. 61/628,074, filed Oct. 24, 2011, which is incorporated herein by reference.

### BACKGROUND OF THE INVENTION

1. Field of the Invention

The present invention relates to a multiport RJ connector including at least three rows of vertically stacked RJ connectors with corresponding contacts extending to the bottom wall of the multiport RJ connector for insertion into a printed circuit board (PCB). The invention includes a stack of at least three RJ-type female connectors in a common connector body which can be installed on a PCB. The connector body of each multiport RJ connector may optionally be attached to the connector body of another multiport RJ connector to form a higher density of connectors.

2. Description of Related Art

RJ connectors are electrical connectors that are used for networking and computer products. RJ connectors are also utilized in the telephone industry.

Modular connectors are commonly used for telephone systems, data networks, and low-speed serial connections. These connectors are inexpensive, relatively simple to terminate, and easy to plug and unplug. A modular connector typically has a clear, plastic body, with a tab or spring latch and a latch divot that cooperate to lock the plug (female connector) and jack (male connector) into place when connected.

In the vernacular used by the technology industry, these modular plugs are called “RJ” connectors. This is technically inaccurate, but the naming convention is widely used. RJ is an acronym for registered jack, which is part of a coding system developed in the 1970s by AT&T to classify telephone services and equipment. The system, called the Universal Service Order Code (USOC), used designations that begin with the letters RJ to denote the capabilities of jacks in a building and how they should be wired in order to connect to a public telephone network.

A registered jack (RJ) is a standardized physical network interface, both jack construction and wiring pattern, for connecting telecommunications or data equipment to a service provided by a local exchange carrier or long distance carrier. The standard designs for these connectors and their wirings are named RJ11, RJ14, RJ21, RJ45, RJ48, etc. Many of these interface standards are commonly used in North America, though some interfaces are used worldwide.

RJ-type female connectors have socket houses (or openings) for insertion of RJ-type male plugs to form a connection. RJ-type female housings are available in many configurations including a one-port, two-ports in a horizontal row and stackable connectors which are stacked rows of RJ connectors. However, these stackable connectors are only made of two rows in current configurations and arrangements.

### SUMMARY OF THE INVENTION

The present invention is a vertical stack of three or more RJ-type female connectors housed in a connector body to increase the density and number of RJ-type female connectors in a single assembly or unit. Because of the increased density of RJ-type female connectors, the present invention also increases the number of contact pins which must be extended and therefore the depth of the connector is increased to allow room for these contact pins to he housed and enclosed in the connector body. The rows of these RJ-type female connectors generally have symmetric orientation which keeps the size of the connector minimal. The symmetric orientation of the connectors in the present invention facilitates a connector body having small size that conserves space.

More specifically, the present invention includes the plurality of vertically stacked RJ-type female connectors in a connector body which can be attached to a connector body of a like stack of RJ-type female connectors to increase the density and the number of ports. In one non-limiting embodiment, the RJ-type female connector of the present invention includes top, middle and bottom rows of RJ-type female connectors in each connector body which can be attached to another connector body which also includes a stack of three RJ-type female connectors so in essence they have a single shielding that surrounds and encases all of the RJ-type female connectors.

The present invention is also a multiport RJ connector assembly that includes a plurality of multiport RJ connectors (connector bodies) coupled together where each multiport RJ connector includes a stack of three RJ-type female connectors. The multiport RJ connector assembly can include configurations of three ports, six ports, nine ports, twelve ports, fifteen ports, eighteen ports, twenty-one ports, etc.

It is envisioned that each multiport RJ connector can be attached to another multiport RJ connector or other types of connectors including USB, HDMI, and SATA connectors. The same interlocking structure can be used for all attachments. In one non-limiting embodiment, this interlocking structure can include plastic pegs protruding from one side of a multiport RJ connector body that insert into and lock into grooves aligned in the same position on another side of another multiport RJ connector body. Therefore, when attaching USB, HDMI, and SATA connectors, the protruding plastic pegs are aligned in the same position to make the attachment.

The same height and size of the multiport RJ connector that includes three RJ-type female connectors can be maintained when combining USB, HDMI, or SATA connectors to attach and lock together.

The present invention is also a method of attaching connectors of all types used in the networking and computer industry. The method includes coupling a connector body that houses three RJ-type female connectors to another connector body that houses two or three or more RJ-type female connectors to increase the density of connectors in a single multiport RJ-type connector assembly.

More specifically, disclosed is a multiport RJ connector comprising: a connector body including vertically stacked RJ-type female connectors, including from a bottom to a top of the connector body first, second and third RJ-type female connectors; each RJ-type female connector includes in an opening of said RJ-type female connector a plurality of contacts including contact portions arranged side-by-side, wherein each contact includes a contact pin that extends from the contact portion toward the bottom of the connector body, wherein the lengths of the contacts pins extending from the contact portions of the third RJ-type female connector are longer than the lengths of the contacts pins extending from the contact portions of the second RJ-type female connector which are longer than the lengths of the contacts pins extending from the contact portions of the first RJ-type female connector; and first and second complementary interlocking structures on opposite sides of the connector body, wherein the first or second interlocking structure of the connector body is configured to mate with a respective second or first complementary interlocking structure of another connector body.

The connector body can include an electrically and magnetically conductive shield on a top, a back and at least one side of the connector body. The connector body can exclude the conductive shield covering at least one of the following: a bottom of the connector body; and a front of the connector body by the opening of each RJ-type female connector.

The opening of each RJ-type female connector can be configured to receive a complementary RJ-type plug.

At least one contact pin can include an extension pin.

The plurality of contacts of each RJ-type female connector can be arranged horizontally side-by-side between sides of the connector body.

The opening of each RJ-type female connector can include a latch divot. The latch divot of two of the three RJ-type female connectors can be oriented in the same direction toward the top or the bottom of the connector body. The latch divot of the other of the three RJ-type female connectors can be oriented in an opposite direction toward the bottom or the top of the connector body.

An LED can be included adjacent to the opening of each RJ-type female connector.

The first interlocking structure can be a slot and the second interlocking structure can be a peg.

The opening of each RJ-type female connector can include a top and a bottom oriented toward the respective top and the bottom of the connector body. The contact portions of the second and third RJ-type female connectors can be disposed at the bottoms of the openings thereof. The contact portions of the first RJ-type female connector are disposed at a top of the openings thereof. One or more integrated magnetic components can be included in the connector body and can be connected to one or more contacts.

Also disclosed is a multiport RJ connector assembly comprising a plurality of individual multiport RJ connectors of the type described above coupled together, with the first interlocking structure of one multiport RJ connector coupled to the second interlocking structure of another multiport RJ connector. The multiport RJ connector can include either: a shield over each multiport RJ connector, or a single shield over said plurality of multiport RJ connectors.

### BRIEF DESCRIPTION OF THE DRAWINGS

FIG. 1 is a perspective of the single instance of a multiport RJ connector of the present invention mounted on a PCB;

FIG. 2A is a view taken along lines II-II in FIG. 1;

FIG. 2B is an isolated and exploded view of a contact pin shown in FIG. 2A including an extension pin in spaced relation to the contact pin;

FIG. 2C is a view of the contact pin and extension pin of FIG. 2B coupled together;

FIG. 3A is a side-by-side perspective view from the back of two instances of the multi-type RJ connector shown in FIG. 1;

FIG. 3B is an end view of a first interlocking structure in the form of a slot in FIG. 3A;

FIG. 3C is a top view of a second interlocking structure in the form of a peg or wedge spaced from a sidewall of the multiport RJ connector by a standoff;

FIG. 4 is an isolated perspective view showing the insertion of the second interlocking structure (peg) of FIG. 3C into the first interlocking structure (slot) of FIG. 3B;

FIG. 5 is a perspective view from the back of three instances of the multiport RJ connectors of the type shown in FIG. 1 coupled together via the first and second interlocking structures thereof;

FIG. 6 is a view taken along lines VI-VI in FIG. 3A;

FIG. 7 is an isolated view of a single instance of a contact of the RJ-type female connectors of FIG. 1, including an RJ contact portion and a contact pin portion; and

FIG. 8 is a front view of four instances of the multiport RJ connector shown in FIG. 1 in spaced relation atop of a PCB including arrows illustrating the movement of the multiport RJ connectors together to form a multiport RJ connector assembly comprised of four multiport RJ connectors coupled together via their respective first and second interlocking structures.

### DETAILED DESCRIPTION OF THE INVENTION

The present invention will be described with reference to the accompanying figures where like reference numbers correspond to like elements.

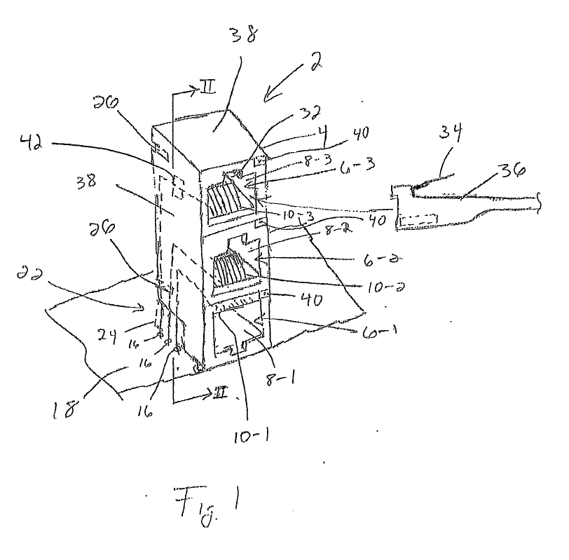

With reference to FIG. 1, a multiport RJ connector 2 of the present invention comprises a connector body 4 housing a plurality of three or more vertically stacked RJ-type female connectors 6. In the multiport RJ connector 2 shown in FIG. 1, connector body 4 houses first, second and third RJ-type female type connectors 6-1, 6-2, 6-3, respectively. The illustration and discussion of multiport RJ connector 2 having three RJ-type female connectors 6, however, is not to be construed as limiting the invention since it is envisioned that connector body 4 can include four or more vertically stacked RJ-type female connectors 6.

RJ-type female connectors 6-1, 6-2, and 6-3 include openings 8-1, 8-2, and 8-3, respectively. Opening 8-1 includes a plurality of contacts 10-1 (shown in phantom) arranged side-by-side in opening 8-1. Similarly, opening 8-2 includes a plurality of contacts 10-2 arranged side-by-side and opening 8-3 includes a plurality of contacts 10-3 arranged side-by-side.

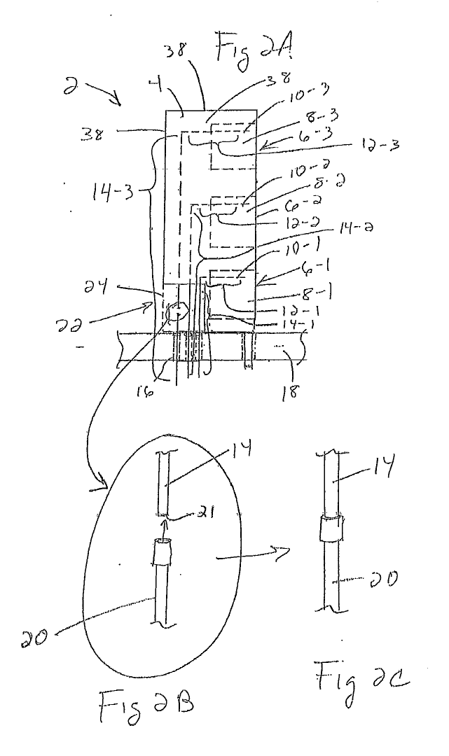

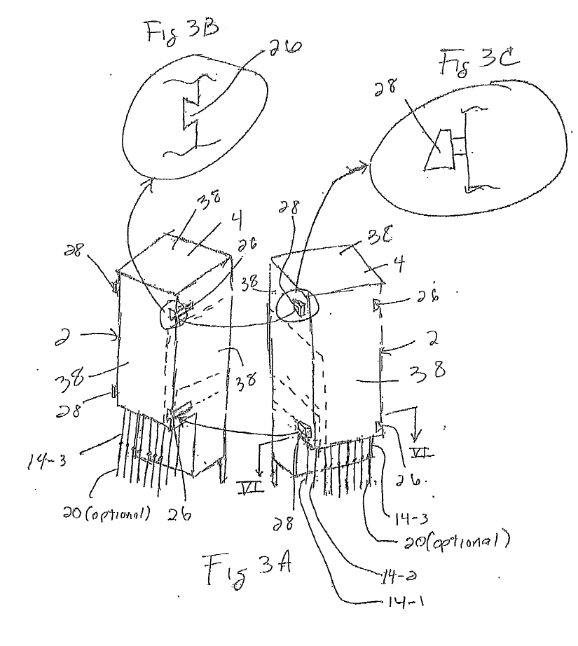

With reference to FIGS. 2A-2C and with continuing reference to FIG. 1, each contact 10-1 includes an RJ contact portion 12-1 and a contact pin 14-1 that extends from contact portion 12-1 toward the bottom of connector body 4 for insertion in through-holes 16 of a printed circuit board (PCB) 18.

Each contact 10-2 includes a contact portion 12-2 and a contact pin 14-2 that extends from contact portion 12-2 toward the bottom of connector body 4 for insertion in a through-hole 16 of PCB 18. Lastly, each contact 10-3 includes an RJ contact portion 12-3 and a contact pin 14-3 that extends from contact portion 12-3 toward the bottom of connector body 4 for insertion in a through-hole 16 of PCB 18. As shown in FIGS. 2B and 2C, an extension pin 20 may be coupled to a distal end 21 of any contact pin 14 to increase the length thereof as necessary to facilitate insertion of said contact pin 14 into a through-hole 16 of PCB 18.

While FIGS. 1 and 2A show the distal ends of contact pins 14 extending from a notch 22 in connector body 4, this is not to be construed as limiting the invention since it is envisioned that connector body 4 can be formed without notch 22, as shown by phantom line 24 in FIGS. 1 and 2A.

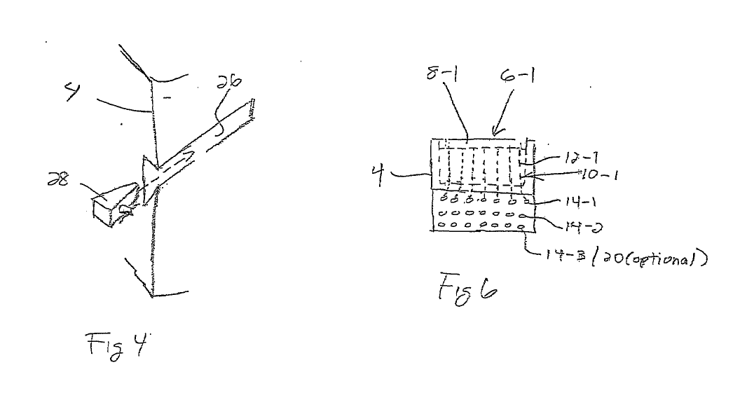

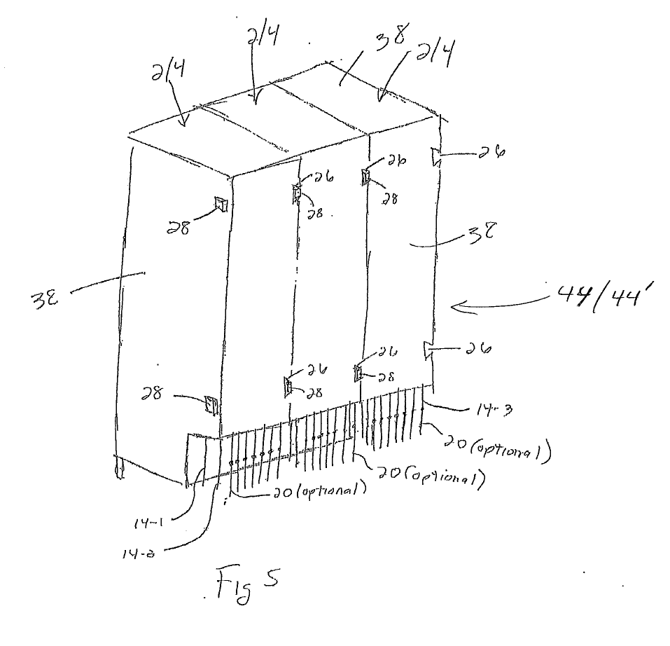

With reference to FIGS. 3A-3C and with continuing reference to FIGS. 1 and 2A, a perspective view of the back of two multiport RJ connectors 2 is shown. As can be seen in this view, each multiport RJ connector 2 includes first and second complementary interlocking structures 26 and 28 on opposite sides of connector body 4. In the illustrated embodiment, each instance of first interlocking structure 26 is a slot and each instance of second interlocking structure 28 is a peg. As can be seen in FIGS. 3A-3C, the first or second interlocking structure of one connector body 4 is configured to mate with a respective second or first complementary interlocking structure of the other connector body 4. The illustration and discussion herein of first and second interlocking structures 26 and 28 being a slot and a peg, however, is not to be construed as limiting the invention since the use of other complementary interlocking structures is envisioned.

FIG. 4 shows an isolated view of one peg 28 and one slot 26, wherein peg 28 is inserted (as shown by the dashed arrow in FIG. 4) into slot 26 from a back side of connector body 4.

FIG. 5 shows a back perspective view of three multiport RJ connectors 2 coupled together via the first and second complementary interlocking structures 26 and 28 of adjacent connector bodies 4.

FIG. 6 is a cross-section taken along lines VI-VI in FIG. 3A more clearly illustrating the array of contact pins 14-1-14-3. In the illustrated embodiment, contact pins 14-1-14-3 form a 3×7 array of contact pins 14. However, this is not to be construed as limiting the invention since the use of any size array of contact pins is envisioned.

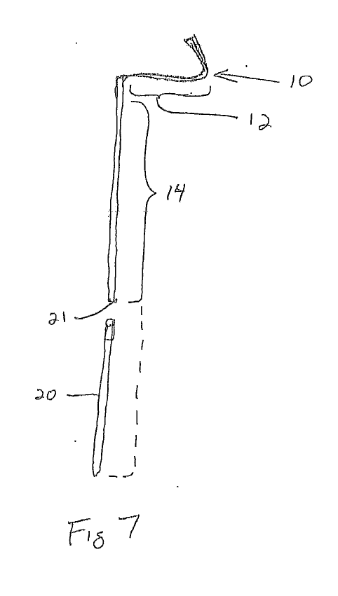

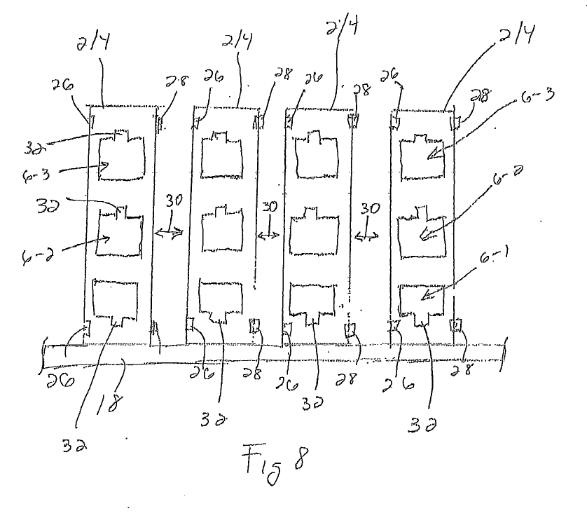

FIG. 7 is an isolated view of a single contact 10 including RJ contact portion 12 and contact pin portion 14. If extension pin 20 is utilized to extend the length of contact pin 14, contact pin 14 comprises its original contact pin portion plus extension pin 20.

FIG. 8 shows four multiport RJ connectors 2/connector bodies 4 spaced from each other atop of PCB 18. The four multiport RJ connectors 2 shown in FIG. 8 can be moved together as shown by arrows 30 and locked together via first and second interlocking structures 26 and 28 on adjacent connectors 2. The contact pins of the four multiport RJ connectors 2 can then be inserted into through-holes (not shown in FIG. 8) in PCB 18 and affixed (soldered) thereto in a manner known in the art.

As shown especially in FIG. 1, each RJ-type female connector 6 includes a latch divot 32 for mating with a spring latch 34 of a mating RJ-type male connector 36 during insertion thereof into an opening 8 of one of the RJ-type female connectors 6. As shown in FIGS. 1 and 8, the latch divot 32 of each instance of RJ-type female connector 6-1 is oriented toward the bottom of the corresponding connector body 4. In contrast, the latch divots 32 of the RJ-type female connectors 6-2 and 6-3 of each instance of multiport RJ connector 2 are oriented toward the top of connector body 4. The arrangement of RJ-type female connectors 6-1-6-3 with one latch divot facing toward the bottom (or top) and the other two latch divots facing toward the top (or bottom) facilitates the compact routing of contact pins 14-1 and 14-3 (and any extension pins 20). The arrangement of the latch divots 32 also facilitates a more compact arrangement of RJ-type female connectors 6-1-6-3 and a lower overall height of connector body 4 than could be achieved if all of the latch divots 32 were oriented in the same direction (toward the top of connector body 4 or the bottom of connector body 4).

Because of the orientation of the latch divots 32 of each RJ-type female connector 6 shown in FIG. 1, the contact portions 12 of RJ-type female connector 6-2 and 6-3 are disposed or oriented at the bottoms of openings 8-2 and 8-3 while the RJ contact portions 12-1 of RJ-type female connector 6-1 are disposed or oriented at the top of opening 8-1.

Desirably, each multiport RJ connector 2 can optionally include an electrically and magnetically conductive (ground) shield 38 on a top side, back side, and at least one side (and desirably both sides) of connector body 4. Because each instance of multiport RJ connector 2 will be coupled to a PCB 18, the bottom of connector body (positioned adjacent PCB 18 in use) optionally does not include a portion of conductive shield 38 thereon. Similarly, conductive shield 38 is not included over opening 8 of each RJ-type female connector 6.

When a plurality of multiport RJ connectors 2, each including a shield 38, is coupled together (FIG. 5) via first and second complementary interlocking structures 26 and 28 of adjacent connector bodies 4, the shields 38 of these adjacent connectors 2 can: (1) touch (directly, via interlocked interlocking structures 26 and 28, or both) to form an electrical connection therebetween, (2) be electrically connected via any suitable means in electrical and mechanical contact with a ground trace or plane of PCB 18 in a manner known in the art, or (3) both, whereupon an electrically and magnetically conductive (ground) shield 44 (FIG. 5), comprised of the shields 38 of the plurality of adjacent connectors 2, is formed around said plurality of multiport RJ connectors 2 and between adjacent ones of said multiport RJ connectors 2.

Alternatively, each multiport RJ connector 2 can exclude shield 38. In this alternative embodiment, when a plurality of multiport RJ connectors 2 is coupled together (FIG. 5) via first and second complementary interlocking structures 26 and 28 of adjacent connector bodies 4, a single standalone shield 44′, having one or more openings that facilitate access to the openings 8 of the RJ-type female connectors 6 of said plurality of multiport RJ connectors 2, can be positioned over the plurality of coupled adjacent connector bodies 4 to form a ground shield therearound. Shield 44′ can then be electrically connected via any suitable means in electrical and mechanical contact with a ground trace or plane of PCB 18 in a manner known in the art. In this embodiment, no part of shield 44′ is between adjacent multiport RJ connectors 2.

Each RJ-type female connector 6 can optionally include adjacent the opening 8 thereof an LED 40 (or any other suitable style or type of lamp). Each LED 40 can be connected as desired to a signal or power contact 10 and a ground contact 10 or shield 38 in a manner that enables LED 40 to emit light in response to the application of power or the transmission of data via the signal or power contact 10.

One or more or all of the RJ-type female connectors 6-1-6-3 can optionally include one or more integrated magnetic components 42 (FIG. 1) in the body 4 of multiport RJ connector 2. Each integrated magnetic component can be a wire-wound component, such as, without limitation, a wire-wound inductor. Details regarding other devices that can comprise integrated magnetic components 42 can be found in U.S. Pat. No. 8,177,585 and U.S. Pat. No. 8,033,871, which are incorporated herein by reference. Each integrated magnetic component may be connected to one or more contacts 10 as deemed suitable and/or desirable by one of ordinary skill in the art.

The present invention has been described with reference to the accompanying figures. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A multiport RJ connector comprising:
a connector body including vertically stacked RJ-type female connectors, including from a bottom to a top of the connector body first, second and third RJ-type female connectors;
each RJ-type female connector including in an opening of said RJ-type female connector a plurality of contacts including contact portions arranged side-by-side, wherein each contact includes a contact pin that extends from the contact portion toward the bottom of the connector body, wherein the lengths of the contacts pins extending from the contact portions of the third RJ-type female connector are longer than the lengths of the contacts pins extending from the contact portions of the second RJ-type female connector which are longer than the lengths of the contacts pins extending from the contact portions of the first RJ-type female connector; and
first and second complementary interlocking structures on opposite sides of the connector body, wherein the first or second interlocking structure of the connector body is configured to mate with a respective second or first complementary interlocking structure of another connector body.

2. The connector of claim 1, wherein the connector body includes an electrically and magnetically conductive shield on a top, a back and at least one side of the connector body.

3. The connector of claim 2, wherein the connector body does not include the conductive shield covering at least one of the following:
a bottom of the connector body; and
a front of the connector body by the opening of each RJ-type female connector.

4. The connector of claim 1, wherein the opening of each RJ-type female connector is configured to receive a complementary RJ-type plug.

5. The connector of claim 1, wherein at least one contact pin comprises an extension pin.

6. The connector of claim 1, wherein the plurality of contacts of each RJ-type female connector are arranged horizontally side-by-side between sides of the connector body.

7. The connector of claim 1, wherein:
the opening of each RJ-type female connector includes a latch divot;
the latch divot of two of the three RJ-type female connectors are oriented in the same direction toward the top or the bottom of the connector body; and
the latch divot of the other of the three RJ-type female connectors is oriented in an opposite direction toward the bottom or the top of the connector body.

8. The connector of claim 1, further including an LED adjacent to the opening of each RJ-type female connector.

9. The connector of claim 1, wherein:
the first interlocking structure is a slot; and
the second interlocking structure is a peg.

10. The connector of claim 1, wherein:
the opening of each RJ-type female connector includes a top and a bottom oriented toward the respective top and the bottom of the connector body;
the contact portions of the second and third RJ-type female connectors are disposed at the bottoms of the openings thereof; and
the contact portions of the first RJ-type female connector are disposed at a top of the openings thereof.

11. The connector of claim 1, further including a magnetic component inside the connector body connected to at least one contact.

12. A multiport RJ connector assembly comprising a plurality of multiport RJ connectors of claim 1 coupled together, with the first interlocking structure of one multiport RJ connector coupled to the second interlocking structure of another multiport RJ connector.

13. The multiport RJ connector assembly of claim 12, further including either:
a shield over each multiport RJ connector; or
a single shield over said plurality of multiport RJ connectors.
